(19) United States
(12) Patent Application Publication
(10) Pub. No.: US 2025/0329055 A1
(43) Pub. Date: Oct. 23, 2025

(54) METHOD AND APPARATUS FOR MOUNTING IMAGE LAYER FILE, AND DEVICE

(71) Applicant: Beijing Baidu Netcom Science Technology Co., Ltd., Beijing (CN)

(72) Inventors: Ruiyao Yao, Beijing (CN); Ran Zheng, Beijing (CN); Ruiqing Zhuang, Beijing (CN); Manxiang Wen, Beijing (CN); Jiao Luo, Beijing (CN)

(21) Appl. No.: 19/238,643

(22) Filed: Jun. 16, 2025

(30) Foreign Application Priority Data
Dec. 18, 2024 (CN) 202411877288.0

(51) Int. Cl. G06T 9/00; H04L 9/32

(52) U.S. Cl. CPC G06T 9/00; H04L 9/3236

(57) ABSTRACT

The present disclosure provides a method and apparatus for mounting an image layer file, and a device. The present disclosure is related to the field of computing technologies, more particularly, to the field of cloud computing technologies. The specific solution is as follows: in response to an image pull request, acquiring a target file indicated by the image pull request, the target file including at least one image layer file, and the image pull request indicating that the target file is to undergo mounting processing; if it is determined that the image layer file passes a first verification, performing mounting processing on an image layer file in a non-compressed package format, and performing a second verification and mounting processing on an image layer file in a compressed package format. This method is used to improve image pulling efficiency.

### CROSS-REFERENCE TO RELATED APPLICATIONS

This application claims priority to Chinese Patent Application No. 202411877288.0 filed on Dec. 18, 2024, which is hereby incorporated by reference in its entirety.

### TECHNICAL FIELD

The present disclosure relates to the field of cloud computing technologies in computer technologies, more particularly, to a method and apparatus for mounting an image layer file, and a device.

### BACKGROUND

During a single-node image pulling operation, it is necessary to acquire image layer files and mount them to image layers. Subsequently, these image layer files are mounted to a computer.

Therefore, there is an urgent need for a solution that can quickly and efficiently complete the mounting processing on image layer files.

### SUMMARY

The present disclosure provides a method and apparatus for mounting an image layer file, and a device.

According to a first aspect of the present disclosure, a method for mounting an image layer file is provided. The method includes:
in response to an image pull request, acquiring a target file indicated by the image pull request, the target file including at least one image layer file, where the image pull request indicates that the target file will undergo mounting processing;
after determining that the image layer file passes a first verification, performing mounting processing on an image layer file in a non-compressed package format, and performing a second verification and mounting processing on an image layer file in a compressed package format.

According to a second aspect of the present disclosure, an electronic device is provided. The electronic device includes at least one processor and a memory communicatively connected with the at least one processor. The memory stores instructions executable by the at least one processor, and the instructions are executed by the at least one processor to cause the at least one processor to execute the method according to the first aspect.

According to a third aspect of the present disclosure, a non-transitory computer-readable storage medium having computer instructions stored thereon is provided. The computer instructions are used to cause a computer to execute the method according to the first aspect.

The technologies of the present disclosure resolve the problem of low image pulling efficiency.

It should be understood that content described in this section is neither intended to identify key or important features of embodiments of the present disclosure, nor to limit the scope of the present disclosure. Other features of the present disclosure will become easy to understand through the following description.

### BRIEF DESCRIPTION OF DRAWINGS

Drawings are used to better understand the solutions, and do not constitute a limitation to the present disclosure. Among them:

FIG. 1 is a schematic diagram of a first embodiment of the present disclosure.

FIG. 2 is a schematic diagram of a second embodiment of the present disclosure.

FIG. 3 is a schematic diagram of a third embodiment of the present disclosure.

FIG. 4A and FIG. 4B are exemplary diagrams comparing disk throughputs during a mounting process of image layer files provided by an embodiment of the present disclosure.

FIG. 5 is a schematic diagram of a fourth embodiment of the present disclosure.

FIG. 6 is a schematic diagram of a fifth embodiment of the present disclosure.

FIG. 7A to FIG. 7D are exemplary diagrams comparing time durations corresponding to mounting processes of different image layer files provided by an embodiment of the present disclosure.

FIG. 8 is a block diagram of an apparatus for mounting an image layer file according to an embodiment of the present disclosure.

FIG. 9 is a block diagram of another apparatus for mounting an image layer file according to an embodiment of the present disclosure.

FIG. 10 is a schematic block diagram of an exemplary electronic device for implementing embodiments of the present disclosure.

### DESCRIPTION OF EMBODIMENTS

Exemplary embodiments of the present disclosure are illustrated below in conjunction with the drawings, where various details of the embodiments of the present disclosure are included to facilitate understanding, and they should be regarded as merely exemplary. Therefore, those of ordinary skill in the art should realize that various changes and modifications may be made to the embodiments described herein without departing from the scope and the spirit of the present disclosure. Likewise, for clarity and conciseness, descriptions of well-known functions and structures are omitted in the following description.

The present disclosure provides a method and apparatus for mounting an image layer file, and a device, which are applied in the field of cloud computing technologies in computer technologies, to achieve an effect of improving efficiency in image pull operations.

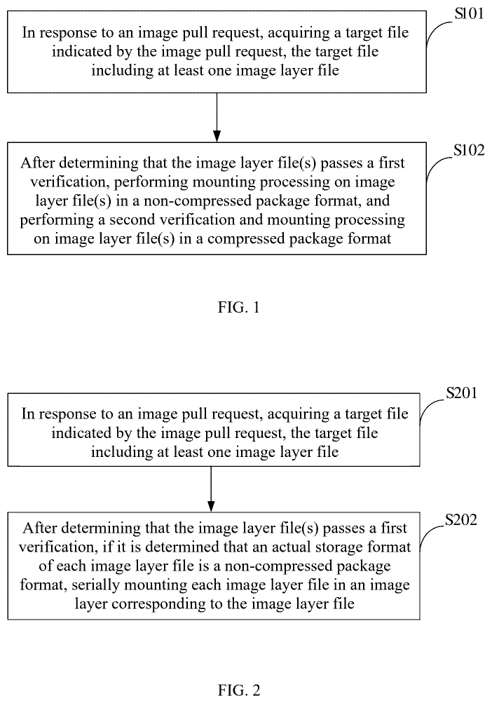

FIG. 1 is a schematic diagram of a first embodiment of the present disclosure. As shown in FIG. 1, the method for mounting an image layer file provided by the first embodiment of the present disclosure includes:

Step S101, in response to an image pull request, acquiring a target file indicated by the image pull request, the target file including at least one image layer file.

Specifically, in response to the image pull request, the target file indicated by the image pull request can be acquired, and the target file includes at least one image layer file.

The image pull request is a request for pulling a target image. The target file is a file of the target image. An image layer file included in the target file corresponds to an image layer of the target image, and the number of image layer files corresponds to the number of image layers included in the target image.

Optionally, the image pull request indicates that the target file is to undergo downloading processing.

The present disclosure does not limit the process of acquiring the target file indicated by the image pull request, that is, the downloading process of the target file. Optionally, the image may be pulled using a command-line tool based on containerization technology. The command-line tool based on containerization technology is not limited in the present disclosure, optionally, it may be Docker or docker pull.

Optionally, the target file may be acquired from a cloud or a terminal storing the target file. Optionally, a target file download request may be sent to the cloud or the terminal storing the target file, to acquire the target file corresponding to the target file download request sent by the cloud or the terminal storing the target file. Optionally, the target file download request includes, but is not limited to, information such as a name, version, or tag of the image.

The image pull request indicates a need to perform mounting processing on the target file.

Optionally, after the target file is downloaded, it may be stored in a storage structure of OverlayFS. As an efficient storage driver, OverlayFS is widely used in container technology. During the process of storing the target file in the storage structure of OverlayFS, the target file needs to be presented in image layers of a container root file system (Container RootFS) in a mounted form. The image layers are read-only layers in OverlayFS, corresponding to layers in a Docker image. These layers contain basic data of the image and changes in its construction process. The read-only layers of the container root file system (Container RootFS) include at least one image layer for mounting one of the at least one image layer file. When mounting the at least one image layer file in each image layer, the mounting needs to be performed serially in a bottom-up order. That is, mounting of an upper layer can be performed only after mounting of a lower layer is completed. Optionally, the container root file system (Container RootFS) further includes writable layers (Container Layers). The writable layers are located above the read-only layers and are used to store all changes generated when the container is running. Copy-on-Write (COW) is an important characteristic of OverlayFS: when a write operation is performed on a file in the writable layers, if the file exists in the read-only layers, OverlayFS first copies the file from the read-only layers to the writable layers and then modifies the file in the writable layers, so that the data in the read-only layers remains unchanged, and all changes occur in the writable layers. Optionally, the container root file system (Container RootFS) further includes a merged view (Merged View). The merged view is located above the writable layers and is a final file system view presented by OverlayFS to a user. The merged view is obtained by merging multiple layers (including the read-only layers and the writable layers). When users access the file system through this view, they see a combined result of these layers. In container technologies such as Docker, the Merged View corresponds to a mounting point of the container, and users access the file system in the container through this mounting point.

Step S102, after determining that the image layer file(s) passes a first verification, performing mounting processing on image layer file in a non-compressed package format, and performing a second verification and mounting processing on image layer file in a compressed package format.

Specifically, after the target file indicated by the image pull request is acquired as described in the step S101, the first verification processing may be performed on the image layer file(s) included in the target file. If it is determined that at least one of the image layer file(s) included in the target file fails the first verification processing, prompt information indicating that the first verification processing failed is generated and presented.

The first verification is a process of verifying the acquired image layer file according to a storage format of this image layer file. The present disclosure does not limit the process of performing the first verification processing. Optionally, the first verification processing may be performed by calculating a hash value of the image layer file.

Specifically, if it is determined that all image layer files included in the target file pass the first verification processing, then after determining that the image layer file(s) passes the first verification, it is possible to perform the mounting processing on the image layer file in the non-compressed package format, and perform the second verification and mounting processing on the image layer file in the compressed package format.

The image layer file included in the target file acquired in the step S101 is an image layer file in a compressed package format, such as a “tar.gz” compressed package, or an image layer file in a non-compressed package format, such as a “tar” file package.

The image layer file for which the mounting processing is performed is a file in a non-compressed package format. Therefore, if the image layer file acquired in the step S101 is a file in a compressed package format, decompression processing needs to be performed on the image layer file before the mounting processing. The second verification is a process of verifying the image layer file to be mounted.

In prior art, after determining that the image layer file passes the first verification, regardless of whether the acquired image layer file is an image layer file in a compressed package format or an image layer file in a non-compressed package format, a second verification and mounting processing are conducted on each image layer file to ensure accuracy of the image layer file. However, the second verification and mounting processing of each image layer file results in low mounting efficiency of the image layer file, thereby causing a problem of low image pulling efficiency.

Specifically, based on the above description of the mounting process and the second verification, in the embodiments provided by the present disclosure, if the acquired image layer file is a file in a non-compressed package format, the verification of the image layer file in the non-compressed package format has been completed in the first verification process described above, so that the mounting processing can be directly performed on the image layer file in the non-compressed package format. If the acquired image layer file is a file in a compressed package format, only the verification of the image layer file in the compressed package format has been completed in the first verification process described above, and thus the second verification and mounting processing need to be performed on the image layer file in the compressed package format.

Optionally, based on the above description of the second verification, before performing the second verification and the mounting processing on the image layer file in the compressed package format, decompression processing may also be performed on the image layer file in the compressed package format.

The present disclosure does not limit the process of performing the mounting processing on the image layer file in the non-compressed package format and the process of performing the second verification and the mounting processing on the image layer file in the compressed package format. Optionally, different processing manners may be selected to carry out the mounting processing on the image layer file in the non-compressed package format, as well as the second verification and the mounting processing on the image layer file in the compressed package format according to an actual storage format of each image layer file included in the target file.

Optionally, during the process of performing the second verification processing on the image layer file in the compressed package format, if it is determined that at least one of the image layer file in the compressed package format fails the second verification processing, prompt information indicating that the second verification processing failed is generated and presented.

In the embodiment of the present disclosure, a target file indicated by an image pull request is acquired in response to the image pull request. The target file includes at least one image layer file. After determining that the image layer file(s) passes a first verification, mounting processing is performed on image layer file(s) in a non-compressed package format, and a second verification and mounting processing are performed on image layer file(s) in a compressed package format. After determining that the image layer file(s) passes the first verification, the second verification is performed only on the image layer file(s) in the compressed package format, the mounting efficiency of image layer files can be enhanced while ensuring mounting accuracy of the image layer files, further improving image pulling efficiency.

In the technical solutions of the present disclosure, the collection, storage, use, processing, transmission, provision, and disclosure of user's personal information involved all comply with provisions of relevant laws and regulations and do not violate public order and morality.

In order to make readers understand the implementation principle of the present disclosure more deeply, the embodiment shown in FIG. 1 is further detailed below in conjunction with FIG. 2 to FIG. 9.

FIG. 2 is a schematic diagram of a second embodiment of the present disclosure. As shown in FIG. 2, the method for mounting an image layer file provided by the second embodiment of the present disclosure includes:

Step S201, in response to an image pull request, acquiring a target file indicated by the image pull request, the target file including at least one image layer file.

The image pull request indicates a need to perform mounting processing on the target file.

Specifically, for a detailed description of this step, reference may be made to the description in the step S101, which will not be repeated here.

Step S202, after determining that the image layer file(s) passes a first verification, if it is determined that an actual storage format of each image layer file is a non-compressed package format, serially mounting each image layer file in an image layer corresponding to the image layer file.

Specifically, after determining that the image layer files pass the first verification, if it is determined that the actual storage formats of all image layer files are the non-compressed package format, the image layer files may be serially mounted in the image layers corresponding to the image layer files.

Based on the description of the second verification in the step S102, after determining that the image layer files pass the first verification, if it is determined that the actual storage formats of all image layer files are the non-compressed package format, it is determined that no second verification is required for the image layer files. Therefore, the mounting processing may be directly performed on each image layer file.

Based on the descriptions of OverlayFS and the container root file system (Container RootFS) in the step S101, when mounting the image layer file to the image layer of the container root file system (Container RootFS), the mounting needs to be performed serially in a bottom-up order. Thus, during the process of directly performing the mounting processing on each image layer file as described above, the image layer files may be serially mounted in the image layers corresponding to the image layer files.

In the embodiment of the present disclosure, a target file indicated by an image pull request is acquired in response to the image pull request. The target file includes at least one image layer file. After determining that the image layer file(s) passes a first verification, if it is determined that actual storage formats of all image layer files are non-compressed package format, the image layer files are serially mounted in the image layers corresponding to these image layer files. If it is determined that the actual storage formats of all image layer files are the non-compressed package format, no decompression processing or second verification processing is required for any image layer file, in this way, the mounting efficiency of image layer files can be improved, and the image pulling efficiency is further improved.

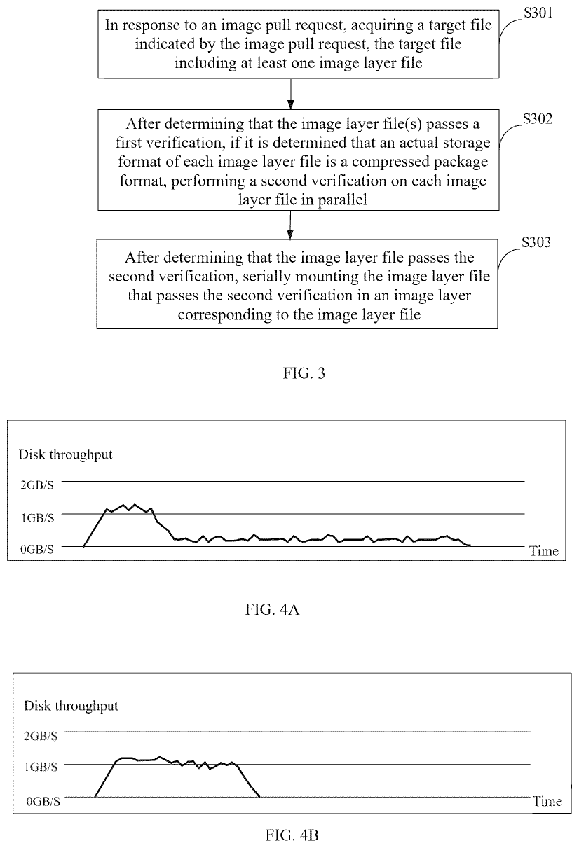

FIG. 3 is a schematic diagram of a third embodiment of the present disclosure. As shown in FIG. 3, the method for mounting an image layer file provided by the third embodiment of the present disclosure includes:

Step S301, in response to an image pull request, acquiring a target file indicated by the image pull request, the target file including at least one image layer file.

The image pull request indicates a need to perform mounting processing on the target file.

Specifically, for a detailed description of this step, reference may be made to the description in the step S101, which will not be repeated here.

Step S302, after determining that the image layer file(s) passes a first verification, if it is determined that an actual storage format of each image layer file is a compressed package format, performing a second verification on each image layer file in parallel.

Specifically, after determining that the image layer file(s) passes the first verification, if it is determined that the actual storage formats of all image layer files are the compressed package format, the second verifications may be performed on the image layer files in parallel.

Based on the description of the second verification in the step S102, after determining that the image layer file passes the first verification, if it is determined that the actual storage format of each image layer file is the compressed package format, it is determined that each image layer file requires the second verification.

Based on the descriptions of OverlayFS and the container root file system (Container RootFS) in the step S101, when mounting the image layer file to the image layer of the container root file system (Container RootFS), the mounting needs to be performed serially in a bottom-up order, but there is no limitation that the second verifications of image layer files needs to be performed serially. Therefore, the second verifications may be performed on the image layer files in parallel to improve the efficiency of the second verifications, thereby improving the mounting efficiency of the image layer file and further improving the image pulling efficiency.

Optionally, based on the description of the second verification in the step S102, before performing the second verification and the mounting processing on the image layer file in the compressed package format, decompression processing may also be performed on the image layer file in the compressed package format. If the second verifications are performed on the image layer files in parallel, decompression processing may be performed on the image layer files in parallel.

FIG. 4A and FIG. 4B are exemplary diagrams comparing disk throughputs during a mounting process of image layer files provided by an embodiment of the present disclosure. FIG. 4A shows the disk throughput during the mounting process of image layer files when second verifications are performed on image layer files serially, where the disk throughput changes along time. FIG. 4B shows the disk throughput during the mounting process of image layer files when second verifications are performed on image layer files in parallel. Specifically, according to FIG. 4A and FIG. 4B, it can be seen that when the second verifications are performed on the image layer files in parallel, the disk throughput is significantly improved, thereby effectively reducing a mounting duration of image layer files, i.e., improving the mounting efficiency of image layer files and further improving the image pulling efficiency.

Optionally, the image layer file includes a first initial digest. The first initial digest is a hash value determined based on the image layer file in its non-compressed package format.

Specifically, the first initial digest is a hash value determined during a construction process of the image layer file when the image layer file is in the non-compressed package format. The first initial digest is stored in a cloud or a terminal together with the image layer file, and is acquired to the local system along with the acquisition of the image layer file.

Optionally, if the image layer file includes the first initial digest, the process of performing the second verification on each image layer file in parallel may include:
performing the following steps for each image layer file in parallel:
first decompressing the image layer file to obtain a decompressed image layer file, and then calculating a hash value of the decompressed image layer file to obtain a first calculated digest.

The present disclosure does not limit the process of decompressing the image layer file to obtain the decompressed image layer file. Optionally, the process of decompressing the image layer file to obtain the decompressed image layer file corresponds to a compressed package format of the image layer file. Optionally, if the image layer file in the compressed package format is a “tar.gz” compressed package, the decompressed image layer file (that is, the image layer file in the non-compressed package format) is a “tar” file package.

The present disclosure does not limit the process of calculating the hash value of the decompressed image layer file to obtain the first calculated digest. Optionally, the hash value of the decompressed image layer file may be calculated based on a digest algorithm to obtain the first calculated digest. The present disclosure does not limit the digest algorithm, which may be a secure hash algorithm (SHA), such as SHA-1, SHA-224, SHA-256, SHA-384, SHA-512, SHA-3, or may be a message-digest algorithm 5 (MD5), for example.

Second, if the first calculated digest corresponding to the image layer file is consistent with the first initial digest, determining that the image layer file passes the second verification. If it is determined that the first calculated digest corresponding to the image layer file is inconsistent with the first initial digest, determining that the image layer file fails the second verification.

Specifically, if the first calculated digest corresponding to the image layer file is consistent with the first initial digest, it is determined that the hash value, which is determined during the construction process of the image layer file when it is in the non-compressed package format, is consistent with the hash value of the decompressed image layer file calculated before mounting, so it can be determined that the image layer file passes the second verification. If it is determined that the first calculated digest corresponding to the image layer file is inconsistent with the first initial digest, it is determined that the hash value, which is determined during the construction process of the image layer file when it is in the non-compressed package format, is inconsistent with the hash value of the decompressed image layer file calculated before mounting, so it can be determined that the image layer file fails the second verification.

During the process of performing the second verifications on the image layer files in parallel, the second verifications for the image layer files are carried out in parallel by comparing the first calculated digests with corresponding first initial digests, so that the second verifications can be completed more simply and efficiently, the mounting efficiency of the image layer files is further improved, and the image pulling efficiency is further improved.

Optionally, the image layer file includes a plurality of sub-files. Each sub-file has a second initial digest, and the second initial digest is a hash value determined based on the sub-files in a non-compressed package format.

Specifically, based on the above description of the first initial digest, the second initial digest is a hash value determined during a construction process of the image layer file when the sub-file is in the non-compressed package format. The second initial digest is stored in a cloud or a terminal together with the image layer file, and is acquired to the local system along with the acquisition of the image layer file.

The present disclosure does not limit the number of sub-files included in the image layer file. Any number of sub-files that can form the image layer file may be used as the number of sub-files included in the image layer file provided by the present disclosure.

Optionally, if the image layer file includes the plurality of sub-files and each sub-file has a second initial digest, the process of performing the second verification on each image layer file in parallel may include:
performing the following steps for each image layer file in parallel:
first, for a current image layer file, verifying each sub-file of the current image layer file based on a second initial digest of each sub-file of the current image layer file.

The present disclosure does not limit the process of verifying each sub-file of the current image layer file based on the second initial digest of each sub-file of the current image layer file. Optionally, the sub-files of the current image layer file may be verified serially based on the second initial digests of the sub-files of the current image layer file. Optionally, the sub-files of the current image layer file may be verified in parallel based on the second initial digests of the sub-files of the current image layer file.

Second, if it is determined that all of the sub-files of the current image layer file pass the verification, determining that the current image layer file passes the second verification. If it is determined that any of the sub-files of the current image layer file fails the verification, determining that the current image layer file fails the second verification.

Specifically, if it is determined that all of the sub-files of the current image layer file pass the verification, it is determined that the current image layer file passes the second verification. Then, the procedure proceeds to the mounting process described in the step S303.

Specifically, if it is determined that any of the sub-files of the current image layer file fails the verification, it is determined that the current image layer file fails the second verification. Then, prompt information indicating that the second verification failed may be generated and presented.

During the process of performing the second verification on each image layer file in parallel, if the image layer file includes multiple sub-files, the second verifications are performed on the image layer files in parallel based on the second initial digests of the sub-files, so that the second verifications can be completed more simply and efficiently, the mounting efficiency of the image layer files is further improved, and the image pulling efficiency is further improved.

Optionally, the process of verifying each sub-file of the current image layer file based on the second initial digest of each sub-file of the current image layer file may include: serially verifying each sub-file of the current image layer file based on the second initial digest of each sub-file of the current image layer file.

Specifically, if the sub-files of the current image layer file are verified serially based on the second initial digests of the sub-files of the current image layer file, each image layer file verifies only one sub-file at a time. While improving the mounting efficiency of the image layer files through parallel processing between image layers, the problem of excessive disk throughput caused by parallel processing of the image layer files is also avoided.

Alternatively, verifying each sub-file of the current image layer file in parallel based on the second initial digest of each sub-file of the current image layer file.

Optionally, the process of verifying each sub-file of the current image layer file in parallel based on the second initial digest of each sub-file of the current image layer file may include: verifying the sub-files of the current image layer file in full parallel based on the second initial digests of the sub-files of the current image layer file, or verifying the sub-files of the current image layer file in partial parallel based on the second initial digests of the sub-files of the current image layer file.

Among them, full parallel means that all sub-files of the image layer file are processed in parallel. Optionally, the total memory size corresponding to all sub-files in the image layer file may be determined first. If it is determined that the total memory size is less than a preset threshold, the full parallel manner is selected for verification; otherwise, the partial parallel manner is selected. Partial parallel means dividing the sub-files in the image layer file according to the preset threshold, after the division, multiple groups of sub-files are verified in parallel, and sub-files within the same group are verified serially.

Based on the above description of the process of verifying each sub-file of the current image layer file based on the second initial digest of each sub-file of the current image layer file in parallel, on the basis of avoiding the problem of excessive disk throughput caused by parallel processing of the image layer files and improving the mounting efficiency of the image layer files through parallel processing between image layers, the mounting efficiency of the image layer files can be further improved.

If the sub-files of the current image layer file are verified serially based on the second initial digests of the sub-files of the current image layer file, each image layer file verifies only one sub-file at a time. While improving the mounting efficiency of the image layer files through parallel processing between image layers, the problem of excessive disk throughput caused by parallel processing of the image layer files is also avoided. If the sub-files of the current image layer file are verified in parallel based on the second initial digests of the sub-files of the current image layer file, in addition to avoiding the problem of excessive disk throughput caused by parallel processing of the image layer files and improving the mounting efficiency of the image layer files through parallel processing between image layers, the mounting efficiency of the image layer files can be further improved. Based on the above description, the mounting efficiency of the image layer files can be improved, and the image pulling efficiency is further improved.

Optionally, the process of serially verifying each sub-files of the current image layer file based on the second initial digest of each sub-file of the current image layer file includes:
first decompressing a sub-file of the current image layer to obtain a decompressed sub-file, and then calculating a hash value of the decompressed sub-file to obtain a second calculated digest.

For a detailed description of this step in the present disclosure, reference may be made to the description of the process of decompressing the image layer file to obtain the decompressed image layer file and calculating the hash value of the decompressed image layer file to obtain the first calculated digest above, which will not be repeated here.

Second, if it is determined that the second calculated digest of the sub-file is consistent with the second initial digest of the sub-file, it is determined that the sub-file passes the verification. If it is determined that the second calculated digest of the sub-file is inconsistent with the second initial digest of the sub-file, the sub-file is determined to fail the verification.

For a detailed description of this step in the present disclosure, reference may be made to the description above: if the first calculated digest corresponding to the image layer file is consistent with the first initial digest, the image layer file is determined to pass the second verification; if it is determined that the first calculated digest corresponding to the image layer file is inconsistent with the first initial digest, the image layer file is determined to fail the second verification, which will not be repeated here.

During the process of verifying each sub-file of the current image layer file based on the second initial digest of each sub-file of the current image layer file, the second verification is performed by comparing the second calculated digest with the second initial digest, so that the second verification can be completed more simply and efficiently, the mounting efficiency of the image layer files is further improved, and the image pulling efficiency is further improved.

Step S303: after determining that the image layer file passes the second verification, serially mounting the image layer file that passes the second verification in an image layer corresponding to the image layer file.

Specifically, after determining that each image layer file passes the second verification through the process described in the step S302, the image layer files that pass the second verifications are serially mounted in image layers corresponding to these image layer files.

Optionally, if it is determined that at least one of the image layer file(s) fails the second verification, prompt information indicating that the second verification processing failed is generated and presented.

In the embodiment of the present disclosure, a target file indicated by an image pull request is acquired in response to the image pull request. The target file includes at least one image layer file. After determining that the image layer files pass the first verification, if it is determined that actual storage formats of all image layer files are compressed package format, second verifications are performed on the image layer files in parallel, and after determining that the image layer files pass the second verification, the image layer files that pass the second verification are serially mounted in the image layers corresponding to the image layer files. If it is determined that the actual storage formats of all image layer files are compressed package format, performing the second verifications on the image layer files in parallel, the efficiency of the second verifications is improved, thereby improving the mounting efficiency of the image layer files and further improving the image pulling efficiency.

FIG. 5 is a schematic diagram of a fourth embodiment of the present disclosure. As shown in FIG. 5, the method for mounting an image layer file provided by the fourth embodiment of the present disclosure includes:

Step S501: in response to an image pull request, acquiring a target file indicated by the image pull request, the target file including at least one image layer file.

The image pull request indicates a need to perform mounting processing on the target file.

Specifically, for a detailed description of this step, reference may be made to the description in the step S101, which will not be repeated here.

Step S502, after determining that the image layer file(s) passes a first verification, according to a mounting order of image layer files, performing mounting processing on an image layer file in a non-compressed package format, and performing mounting processing on an image layer file in a compressed package format after performing a second verification.

Specifically, after determining that the image layer files pass the first verification, if it is determined that the actual storage formats of the image layer files include both the compressed package format and the non-compressed package format, then according to the mounting order of the image layer files, mounting processing may be performed on the image layer file(s) in the non-compressed package format, and mounting processing may be performed on the image layer file(s) in the compressed package format after performing the second verification on the image layer file(s) in the compressed package format.

The mounting order of image layer files is the order in which the image layer files are serially mounted as described in the above embodiments.

Specifically, if the actual storage format of the image layer file is the non-compressed package format, as described in the step S202, it is determined that no second verification is required for the image layer file. Therefore, the mounting processing can be directly performed on the image layer file.

Specifically, if the actual storage format of the image layer file is the compressed package format, as described in the step S302, it is determined that the image layer file requires the second verification. Therefore, the mounting processing may be performed on the image layer file in the compressed package format after performing the second verification. Optionally, before performing the second verification processing on the image layer file in the compressed package format, decompression processing may also be performed on the image layer file in the compressed package format.

In the embodiment of the present disclosure, a target file indicated by an image pull request is acquired in response to the image pull request. The target file includes at least one image layer file. After determining that the image layer file passes the first verification, according to the mounting order of image layer files, mounting processing is performed on the image layer file in the non-compressed package format, and mounting processing is performed on the image layer file in the compressed package format after performing the second verification. If it is determined that the image layer files include a file in the non-compressed package format, decompression processing and second verification processing do not need to be performed on the image layer file in the non-compressed package format, the mounting efficiency of the image layer files can be improved, and the image pulling efficiency is further improved.

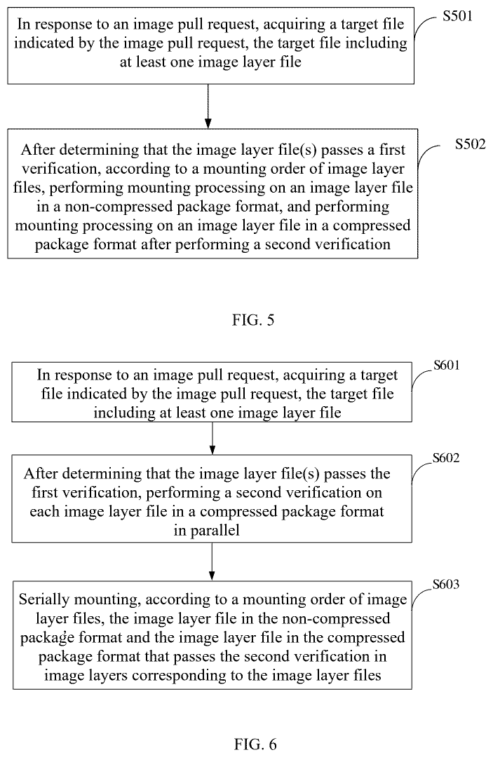

FIG. 6 is a schematic diagram of a fifth embodiment of the present disclosure. As shown in FIG. 6, the method for mounting an image layer file provided by the fifth embodiment of the present disclosure includes:

Step S601, in response to an image pull request, acquiring a target file indicated by the image pull request, the target file including at least one image layer file.

The image pull request indicates a need to perform mounting processing on the target file.

Specifically, for a detailed description of this step, reference may be made to the description in the step S101, which will not be repeated here.

Step S602, after determining that the image layer file(s) passes the first verification, performing a second verification on each image layer file in a compressed package format in parallel.

Specifically, after determining that the image layer files pass the first verification, if it is determined that the actual storage formats of the image layer files include both the compressed package format and the non-compressed package format, and if mounting is performed according to the mounting process of the image layer files described in the step S502, only the process of performing the second verification on the image layer file in the non-compressed package format can be skipped, but this cannot effectively improve the mounting efficiency of the image layer files. With reference to the description in the embodiment shown in FIG. 3, the second verification may be performed in parallel on each image layer file in the compressed package format, so as to further improve the efficiency of the second verification, thereby improving the mounting efficiency of the image layer files and further improving the image pulling efficiency. For the description of the process of performing the second verification on each image layer file in the compressed package format in parallel, reference may be made to the description of the process of performing the second verification on each image layer file in parallel in the step S302, which will not be repeated here.

Optionally, if it is determined that at least one of the image layer file in the compressed package format fails the second verification, prompt information indicating that the second verification processing failed is generated and presented.

Optionally, if it is determined that there is only one image layer file in the compressed package format, the process of performing the second verification on each image layer file in the compressed package format in parallel is meaningless, that is, the effect of improving the mounting efficiency of the image layer files is the same as the effect in the embodiment shown in FIG. 5.

Step S603: serially mounting, according to a mounting order of image layer files, the image layer file in the non-compressed package format and the image layer file in the compressed package format that passes the second verification in image layers corresponding to the image layer files.

Specifically, after performing the second verification on each image layer file in the compressed package format in parallel, the image layer file in the non-compressed package format and the image layer file in the compressed package format that passes the second verification may be serially mounted in image layers corresponding to the image layer files according to the mounting order of image layer files.

For the description of the mounting order of the image layer files, reference may be made to the description in the step S502, which will not be repeated here.

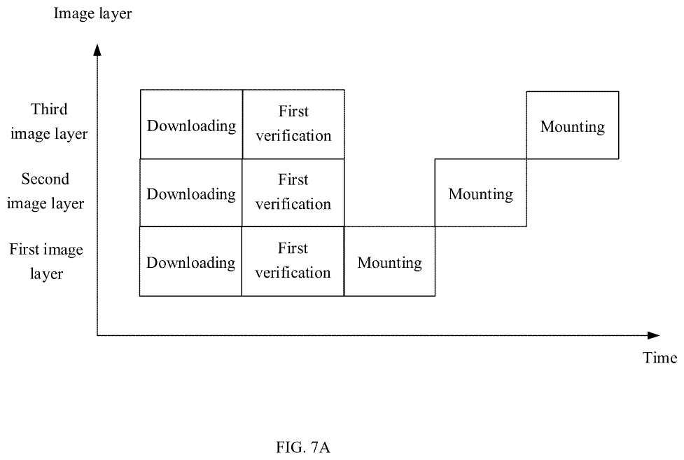

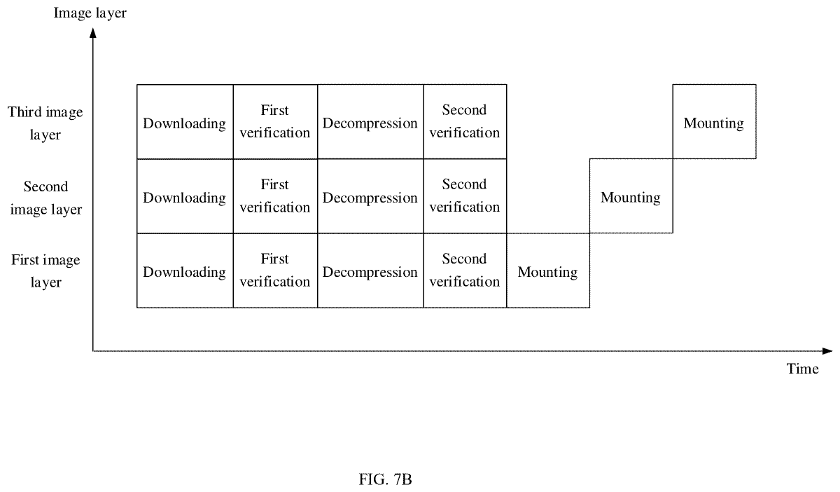

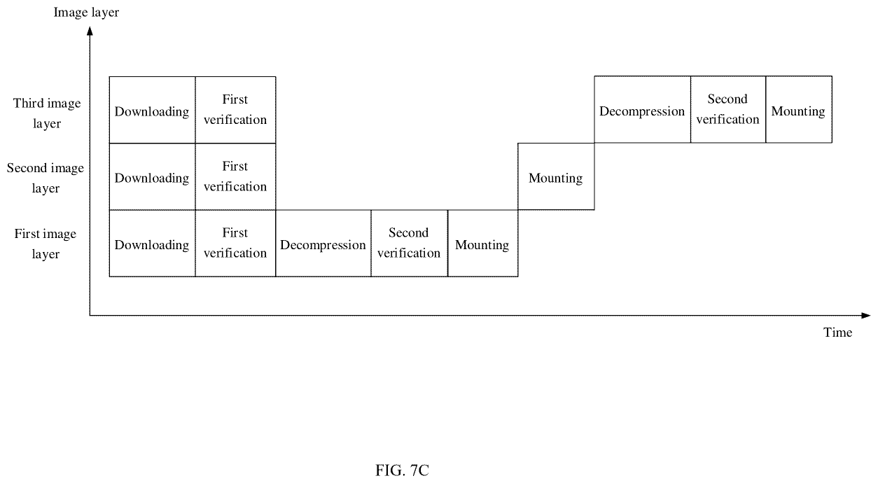

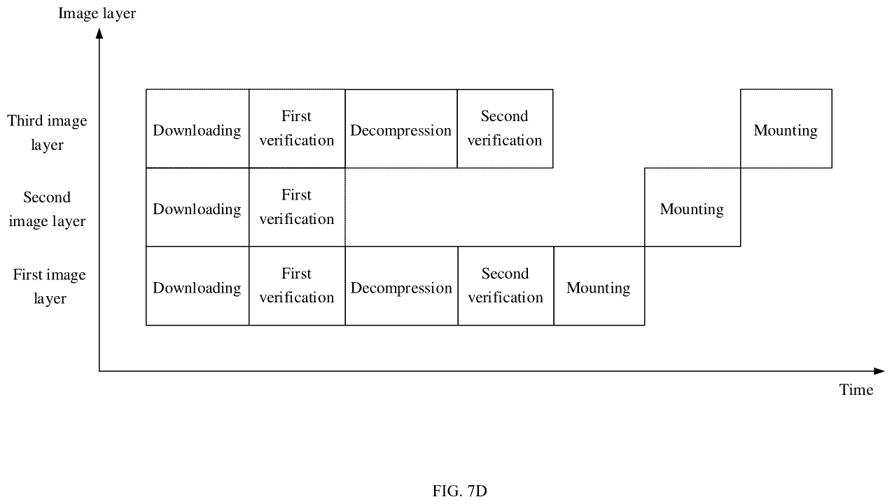

FIG. 7A to FIG. 7D are exemplary diagrams comparing time durations corresponding to mounting processes of different image layer files provided by an embodiment of the present disclosure. FIG. 7A is a time display diagram corresponding to the mounting process of the image layer files provided in the embodiment of FIG. 2. The mounting process of the image layer files involves three image layer files, and each image layer file is in a non-compressed package format. FIG. 7B is a time display diagram corresponding to the mounting process of the image layer files provided in the embodiment of FIG. 3. The mounting process of the image layer files involves three image layer files, and each image layer file is in a compressed package format. FIG. 7C is a time display diagram corresponding to the mounting process of the image layer files provided in the embodiment of FIG. 5. The mounting process of the image layer files involves three image layer files, where image layer files at the first and third layers are in a compressed package format and the image layer file at the second layer is in a non-compressed package format. FIG. 7D is a time display diagram corresponding to the mounting process of the image layer files provided in the embodiment of FIG. 6. The mounting process of the image layer files involves three image layer files, where image layer files at the first and third layers are in a compressed package format and the image layer file at second layer is in a non-compressed package format.

In the embodiment of the present disclosure, a target file indicated by an image pull request is acquired in response to an image pull request. The target file including at least one image layer file. After determining that the image layer files pass a first verification, a second verification is performed in parallel on each image layer file in a compressed package format, and the image layer file in the non-compressed package format and the image layer file in the compressed package format that passes the second verification are serially mounted in image layers corresponding to these image layer files according to a mounting order of image layer files. If it is determined that the image layer files include a file whose actual storage format is the compressed package format, the second verification is performed on each image layer file in the compressed package format in parallel, the efficiency of the second verification processing can be improved, thereby improving the mounting efficiency of the image layer files and further improving the image pulling efficiency.

In some embodiments, the image layer file includes a first initial digest and a third initial digest.

The first initial digest is a hash value determined based on the image layer file in a non-compressed package format. For a description of the first initial digest, reference may be made to the description in the step S302, which will not be repeated here.

The third initial digest is a hash value determined based on the actual storage format of the image layer file.

Specifically, the third initial digest is a hash value of the image layer file in the actual storage format determined during a construction process of the image layer file. The third initial digest is stored in a cloud or a terminal together with the image layer file, and is acquired to the local system along with the acquisition of the image layer file. As described in the step S102, the actual storage format of the image layer file may be compressed package format or non-compressed package format.

The hash values corresponding to the actual storage format and the non-compressed package format of the image layer file can be known through the first initial digest and the third initial digest, thus enabling accurate completion of the first verification and second verification for the image layer file, thereby improving the accuracy of image pulling.

In some embodiments, before performing the mounting processing on the image layer file in the non-compressed package format, and performing the second verification and the mounting processing on the image layer file in the compressed package format, the method includes:
determining the actual storage format of the image layer file according to the first initial digest and the third initial digest of the image layer file, where the actual storage format is the non-compressed package format or the compressed package format.

Specifically, before performing the mounting processing on the image layer file in the non-compressed package format, and performing the second verification and the mounting processing on the image layer file in the compressed package format, it is necessary to determine the actual storage format of the image layer file. Therefore, the actual storage format of the image layer file may be determined according to the first initial digest and the third initial digest of the image layer file.

The present disclosure does not limit the process of determining the actual storage format of the image layer file according to the first initial digest and the third initial digest of the image layer file. Optionally, the actual storage format of the image layer file may be determined according to a size relationship between the first initial digest and the third initial digest.

Based on the description of the first initial digest and the third initial digest, the first initial digest is a hash value determined based on the image layer file in the non-compressed package format, and the third initial digest is a hash value determined based on an actual storage format of the image layer file. Therefore, according to the size relationship between the first initial digest and the third initial digest, the actual storage format of the image layer file can be accurately determined, thereby improving the mounting efficiency of the image layer files and further improving the image pulling efficiency.

Optionally, the process of determining the actual storage format of the image layer file according to the first initial digest and the third initial digest of the image layer file may include: if it is determined that the first initial digest of the image layer file is consistent with the third initial digest of the image layer file, determining that the actual storage format of the image layer file is the non-compressed package format.

Specifically, if it is determined that the first initial digest of the image layer file is consistent with the third initial digest of the image layer file, it is determined that the hash value determined based on the image layer file in the non-compressed package format is the same as the hash value determined based on the actual storage format of the image layer file, and then the actual storage format of the image layer file can be determined as the non-compressed package format.

If it is determined that the first initial digest of the image layer file is inconsistent with the third initial digest of the image layer file, the actual storage format of the image layer file is determined as the compressed package format.

Specifically, if it is determined that the first initial digest of the image layer file is inconsistent with the third initial digest of the image layer file, it is determined that the hash value determined based on the image layer file in the non-compressed package format is different from the hash value determined based on the actual storage format of the image layer file, and then the actual storage format of the image layer file can be determined as the compressed package format.

Since the first initial digest is a hash value determined based on the image layer file in the non-compressed package format and the third initial digest is a hash value determined based on an actual storage format of the image layer file, the actual storage format of the image layer file can be determined easily by determining whether the first initial digest is the same as the third initial digest, thereby improving the mounting efficiency of the image layer files and further improving the image pulling efficiency.

In some embodiments, the process of determining that the image layer file passes the first verification may include:
first calculating a hash value of the image layer file to obtain a third calculated digest.

The present disclosure does not limit the process of calculating the hash value of the image layer file to obtain the third calculated digest. Optionally, reference may be made to the process of calculating the hash value of the decompressed image layer file in the step S302 to obtain the first calculated digest, which will not be repeated here. The image layer file for which the hash value is calculated may be an image layer file in a non-compressed package format or an image layer file in a compressed package format.

If it is determined that the third calculated digest of the image layer file is consistent with the third initial digest, it is determined that the image layer file passes the first verification.

If it is determined that the third calculated digest of the image layer file is consistent with the third initial digest, it is determined that the image layer file passes the first verification. If it is determined that the hash value determined based on the actual storage format of the image layer file during the construction process is consistent with the hash value of the image layer file obtained from the calculation, it is determined that the downloaded image layer file is consistent with the image layer file stored in the cloud or terminal, consequently, it is determined that the image layer file passes the first verification.

If it is determined that the third calculated digest of the image layer file is inconsistent with the third initial digest, it is determined that the image layer file fails the first verification.

If it is determined that the third calculated digest of the image layer file is inconsistent with the third initial digest, it is determined that the image layer file fails the first verification. If it is determined that the hash value determined based on the actual storage format of the image layer file during the construction process is inconsistent with the digest of the image layer file obtained from the calculation, it is determined that the downloaded image layer file is inconsistent with the image layer file stored in the cloud or terminal, consequently, it is determined that the image layer file fails the first verification.

In the process of determining that the image layer file passes the first verification, the first verification is performed by comparing the third calculated digest with the third initial digest, so that the first verification can be completed more simply and efficiently, the mounting efficiency of the image layer files is further improved, and the image pulling efficiency is further improved.

FIG. 8 is a block diagram of an apparatus for mounting an image layer file according to an embodiment of the present disclosure. As shown in FIG. 8, an apparatus 800 for mounting an image layer file provided in a sixth embodiment of the present disclosure includes:
an acquiring unit 801, configured to acquire, in response to an image pull request, a target file indicated by the image pull request, the target file including at least one image layer file, where the image pull request indicates that the target file is to undergo mounting processing;
a mounting unit 802, configured to, after determining that the image layer file passes a first verification, perform mounting processing on an image layer file in a non-compressed package format, and perform a second verification and mounting processing on an image layer file in a compressed package format.

In some embodiments, the mounting unit 802 includes a first mounting module 803, configured to: if it is determined that an actual storage format of each image layer file is the non-compressed package format, serially mount each image layer file in an image layer corresponding to the image layer file.

In some embodiments, the mounting unit 802 further includes a second mounting module 804, configured to: if it is determined that an actual storage format of each image layer file is the compressed package format, perform the second verification on each image layer file in parallel; after determining that the image layer file passes the second verification, serially mount the image layer file that passes the second verification in an image layer corresponding to the image layer file.

In some embodiments, the image layer file includes a first initial digest, and the first initial digest is a hash value determined based on the image layer file in the non-compressed package format. The second mounting module 804 includes a first executing sub-module 806 which is configured to perform the following steps for each image layer file in parallel: decompressing the image layer file to obtain a decompressed image layer file, and calculating a hash value of the decompressed image layer file to obtain a first calculated digest; if the first calculated digest corresponding to the image layer file is consistent with the first initial digest, determining that the image layer file passes the second verification; if it is determined that the first calculated digest corresponding to the image layer file is inconsistent with the first initial digest, determining that the image layer file fails the second verification.

In some embodiments, the image layer file includes a plurality of sub-files, the sub-file has a second initial digest, and the second initial digest is a hash value determined based on the sub-file in the non-compressed package format. The second mounting module 804 includes a second executing sub-module 807 which is configured to perform the following steps for each image layer file in parallel: for a current image layer file, verifying each sub-file of the current image layer file based on a second initial digest of each sub-file of the current image layer file; if it is determined that all of the sub-files of the current image layer file pass the verification, determining that the current image layer file passes the second verification; if it is determined that any of the sub-files of the current image layer file fails the verification, determining that the current image layer file fails the second verification.

In some embodiments, the second executing sub-module 807 is specifically configured to: serially verify each sub-file of the current image layer file based on the second initial digest of each sub-file of the current image layer file; or verify each sub-file of the current image layer file in parallel based on the second initial digest of each sub-file of the current image layer file.

In some embodiments, the second executing sub-module 807 is further specifically configured to: decompress a sub-file of the current image layer to obtain a decompressed sub-file, and calculate a hash value of the decompressed sub-file to obtain a second calculated digest;

if it is determined that the second calculated digest of the sub-file is consistent with the second initial digest of the sub-file, determine that the sub-file passes the verification; if it is determined that the second calculated digest of the sub-file is inconsistent with the second initial digest of the sub-file, determine that the sub-file fails the verification.

In some embodiments, performing the mounting processing on the image layer file in the non-compressed package format, and performing the second verification and the mounting processing on the image layer file in the compressed package format includes:
performing the mounting processing on the image layer file in the non-compressed package format, and performing the mounting processing on the image layer file in the compressed package format after performing the second verification, according to a mounting order of image layer files.

In some embodiments, the mounting unit 802 further includes a third mounting module 805 which is configured to: perform the second verification on each image layer file in the compressed package format in parallel; serially mount, according to a mounting order of image layer files, the image layer file in the non-compressed package format and the image layer file in the compressed package format that passes the second verification in image layers corresponding to the image layer files.

In some embodiments, the image layer file includes a first initial digest and a third initial digest; the first initial digest is a hash value determined based on the image layer file in the non-compressed package format, and the third initial digest is a hash value determined based on an actual storage format of the image layer file.

In some embodiments, the mounting unit 802 further includes a determining module 808, configured to determine the actual storage format of the image layer file according to the first initial digest and the third initial digest of the image layer file. The actual storage format is the non-compressed package format or the compressed package format.

In some embodiments, the determining module 808 is specifically configured to: if it is determined that the first initial digest of the image layer file is consistent with the third initial digest of the image layer file, determine that the actual storage format of the image layer file is the non-compressed package format; if it is determined that the first initial digest of the image layer file is inconsistent with the third initial digest of the image layer file, determine that the actual storage format of the image layer file is the compressed package format.

In some embodiments, the determining module 808 is further specifically configured to: calculate a hash value of the image layer file to obtain a third calculated digest; if it is determined that the third calculated digest of the image layer file is consistent with the third initial digest, determine that the image layer file passes the first verification; if it is determined that the third calculated digest of the image layer file is inconsistent with the third initial digest, determine that the image layer file fails the first verification.

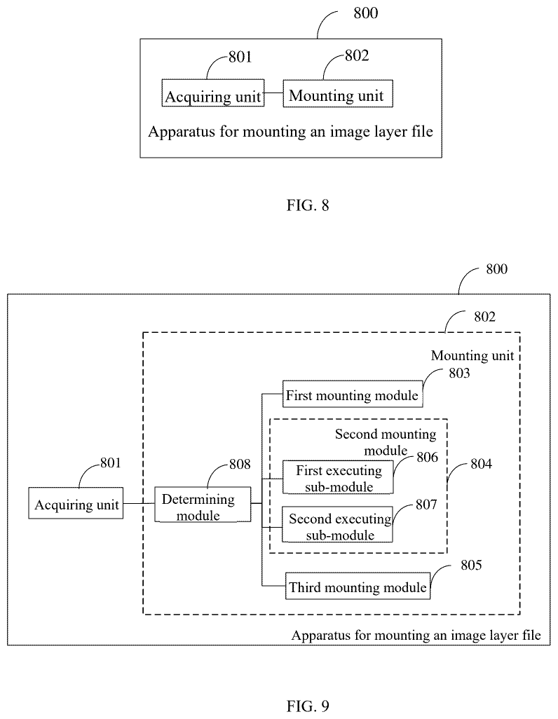

FIG. 9 is a block diagram of another apparatus for mounting an image layer file according to an embodiment of the present disclosure.

According to embodiments of the present disclosure, the present disclosure also provides an electronic device, a readable storage medium and a computer program product.

According to an embodiment of the present disclosure, the present disclosure also provides a computer program product. The computer program product includes a computer program, and the computer program is stored in a readable storage medium. At least one processor of an electronic device can read the computer program from the readable storage medium, and the at least one processor executes the computer program to cause the electronic device to perform the solution provided in any of the foregoing embodiments.

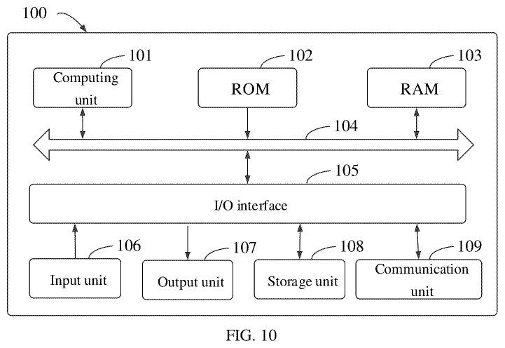

FIG. 10 is a schematic block diagram of an exemplary electronic device 100 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may also represent various forms of mobile apparatuses, such as a personal digital assistant, a cellular phone, a smartphone, a wearable device, and other similar computing apparatuses. Components, their connections and relationships, and their functions shown herein are merely examples, and are not intended to limit implementation of the present application described and/or required herein.

As shown in FIG. 10, the device 100 includes a computing unit 101, which may perform various appropriate actions and processing according to a computer program stored in a read-only memory (ROM) 102 or a computer program loaded from a storage unit 108 to a random-access memory (RAM) 103. In the RAM 103, various programs and data required for operations of the device 100 may also be stored. The computing unit 101, the ROM 102, and the RAM 103 are connected to each other by a bus 104. An input/output (I/O) interface 105 is also connected to the bus 104

A number of components in the device 100 are connected to the I/O interface 105, including: an input unit 106, for example, a keyboard, a mouse, etc.; an output unit 107, for example, various types of displays, speakers, etc.; a storage unit 108, for example, a disk, an optical disc, etc.; and a communication unit 109, for example, a network card, a modem, a wireless communication transceiver, etc. The communication unit 109 allows the device 100 to exchange information/data with other devices through a computer network such as the Internet and/or various telecommunication networks.

The computing unit 101 may be various types of general-purpose and/or special-purpose processing components with processing and computing capabilities. Some examples of the computing unit 101 include, but are not limited to, a central processing unit (CPU), a graphics processing unit (GPU), various dedicated artificial intelligence (AI) computing chips, various computing units for running machine learning model algorithms, a digital signal processor (DSP), and any appropriate processor, controller, microcontroller, etc. The computing unit 101 executes the various methods and processing described above, for example, a method for mounting an image layer file. For example, in some embodiments, the method for mounting an image layer file may be implemented as a computer software program tangibly embodied in a machine-readable medium, such as the storage unit 108. In some embodiments, part or all of computer programs may be loaded into and/or installed on the device 100 via the ROM 102 and/or the communication unit 109. When the computer program is loaded into the RAM 103 and executed by the computing unit 101, one or more steps of the method for mounting an image layer file described above may be performed. Alternatively, in other embodiments, the computing unit 101 may be configured to perform the method for mounting an image layer file by means of any other appropriate means (for example, by means of firmware).

Various embodiments of the systems and the technologies described above herein may be implemented in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or a combination thereof. These various embodiments may include implementations in one or more computer programs, where the one or more computer programs may be executed and/or interpreted on a programmable system including at least one programmable processor, and the programmable processor may be a dedicated or general-purpose programmable processor that may receive data and instructions from a storage system, at least one input apparatus and at least one output apparatus, and transmit data and instructions to the storage system, the at least one input apparatus and the at least one output apparatus.

Program codes used to implement the methods of the present disclosure may be written in any combination of one or more programming languages. These program codes may be provided to a processor or a controller of a general-purpose computer, a special-purpose computer, or other programmable data processing devices, so that when the program codes are executed by the processor or the controller, functions/operations specified in flowcharts and/or block diagrams are implemented. The program codes may be entirely executed on a machine, partly executed on the machine, and as an independent software package, partly executed on the machine and partly executed on a remote machine, or entirely executed on a remote machine or a server.

In the context of the present disclosure, a machine-readable medium may be a tangible medium, which may contain or store a program for use by an instruction execution system, apparatus, or device or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination of the foregoing. More specific examples of the machine-readable storage medium would include an electrical connection based on one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

In order to provide an interaction with a user, the systems and the technologies described herein may be implemented on a computer, the computer being equipped with: a display apparatus for displaying information to the user (for example, a CRT (cathode ray tube) or LCD (liquid crystal display) monitor); a keyboard and a pointing apparatus (for example, a mouse or a trackball) through which the user may provide input to the computer. Other types of apparatuses may also be used to provide an interaction with the user. For example, a feedback provided to the user may be any form of sensory feedback (for example, visual feedback, auditory feedback, or tactile feedback); and input from the user may be received in any form (including an acoustic input, a voice input, or a tactile input).

The systems and the technologies described herein may be implemented in a computing system (for example, as a data server) that includes a back-end component, or a computing system (for example, an application server) that includes a middleware component, or a computing system (for example, a user computer with a graphical user interface or a web browser through which the user may interact with the embodiments of the systems and the technologies described herein) that includes a front-end component, or a computing system that includes any combination of the back-end component, the intermediate component or the front-end component. Components of the system may be connected to each other through digital data communication (for example, a communication network) of any form or medium. Examples of the communication network include: a local area network (LAN), a wide area network (WAN), and the Internet.

A computer system may include a client and a server. The client and the server are generally far away from each other and usually interact through a communication network. A relationship between the client and the server is generated by computer programs that run on corresponding computers and have a client-server relationship with each other. The server may be a cloud server, also known as a cloud computing server or a cloud host, which is a host product in a cloud computing service system, to solve defects of high management difficulty and weak business scalability existing in services of a traditional physical host and a virtual private server (VPS) service. The server may also be a server of a distributed system, or a server combined with a blockchain.

It should be understood that steps may be reordered, added or deleted for various forms of procedures shown above. For example, the steps recorded in the present disclosure may be performed in parallel, sequentially, or in a different order, as long as desired results of the technical solutions disclosed in the present disclosure can be realized, which is not limited herein.

The above specific embodiments do not constitute a limitation to the protection scope of the present disclosure. Those skilled in the art should understand that various modifications, combinations, sub-combinations and substitutions may be made according to design requirements and other factors. Any modification, equivalent replacement, improvement and so on made within the spirit and the principle of the present disclosure shall be included in the protection scope of the present disclosure.

What is claimed is:

1. A method for mounting an image layer file, comprising:
in response to an image pull request, acquiring a target file indicated by the image pull request, the target file comprising at least one image layer file, wherein the image pull request indicates that the target file is to undergo mounting processing;
after determining that the image layer file passes a first verification, performing mounting processing on an image layer file of the at least one image layer file in a case that the image layer file is in a non-compressed package format, and performing a second verification and mounting processing on an image layer file of the at least one image layer file in a case that the image layer file is in a compressed package format.

2. The method according to claim 1, wherein performing the mounting processing on the image layer file of the at least one image layer file in a case that the image layer file is in the non-compressed package format, and performing the second verification and the mounting processing on the image layer file of the at least one image layer file in a case that the image layer file is in the compressed package format comprises:
upon determining that an actual storage format of each image layer file is the non-compressed package format, serially mounting each image layer file in an image layer corresponding to the image layer file.

3. The method according to claim 1, wherein performing the mounting processing on the image layer file of the at least one image layer file in a case that the image layer file is in the non-compressed package format, and performing the second verification and the mounting processing on the image layer file of the at least one image layer file in a case that the image layer file is in the compressed package format comprises:
upon determining that an actual storage format of each image layer file is the compressed package format, performing the second verification on each image layer file in parallel;
after determining that the image layer file passes the second verification, serially mounting the image layer file that passes the second verification in an image layer corresponding to the image layer file.

4. The method according to claim 3, wherein the image layer file comprises a first initial digest, and the first initial digest is a hash value determined based on the image layer file in the non-compressed package format;
wherein performing the second verification on each image layer files in parallel comprises:
performing the following steps for each image layer file in parallel:
decompressing the image layer file to obtain a decompressed image layer file, and calculating a hash value of the decompressed image layer file to obtain a first calculated digest;
upon determining that the first calculated digest corresponding to the image layer file is consistent with the first initial digest, determining that the image layer file passes the second verification; upon determining that the first calculated digest corresponding to the image layer file is inconsistent with the first initial digest, determining that the image layer file fails the second verification.

5. The method according to claim 3, wherein the image layer file comprises a plurality of sub-files, the sub-file has a second initial digest, and the second initial digest is a hash value determined based on the sub-file in the non-compressed package format;
wherein performing the second verification on each image layer file in parallel comprises:
performing the following steps for each image layer file in parallel:
for a current image layer file, verifying each sub-file of the current image layer file based on a second initial digest of each sub-file of the current image layer file;
upon determining that all of the sub-files of the current image layer file pass the verification, determining that the current image layer file passes the second verification; if it is determined that any of the sub-files of the current image layer file fails the verification, determining that the current image layer file fails the second verification.

6. The method according to claim 5, wherein verifying each sub-file of the current image layer file based on the second initial digest of each sub-file of the current image layer file comprises:
serially verifying each sub-file of the current image layer file based on the second initial digest of each sub-file of the current image layer file; or,
verifying each sub-file of the current image layer file in parallel based on the second initial digest of each sub-file of the current image layer file.

7. The method according to claim 5, wherein verifying each sub-file of the current image layer file based on the second initial digest of each sub-file of the current image layer file comprises:
decompressing a sub-file of the current image layer to obtain a decompressed sub-file, and calculating a hash value of the decompressed sub-file to obtain a second calculated digest;
upon determining that the second calculated digest of the sub-file is consistent with the second initial digest of the sub-file, determining that the sub-file passes the verification; upon determining that the second calculated digest of the sub-file is inconsistent with the second initial digest of the sub-file, determining that the sub-file fails the verification.

8. The method according to claim 1, wherein performing the mounting processing on the image layer file of the at least one image layer file in a case that the image layer file is in the non-compressed package format, and performing the second verification and the mounting processing on the image layer file of the at least one image layer file in a case that the image layer file is in the compressed package format comprises:
performing the mounting processing on the image layer file in the non-compressed package format, and performing the mounting processing on the image layer file in the compressed package format after performing the second verification, according to a mounting order of image layer files.

9. The method according to claim 1, wherein performing the mounting processing on the image layer file of the at least one image layer file in a case that the image layer file is in the non-compressed package format, and performing the second verification and the mounting processing on the image layer file of the at least one image layer file in a case that the image layer file is in the compressed package format comprises:
performing the second verification on each image layer file in the compressed package format in parallel;
serially mounting, according to a mounting order of image layer files, the image layer file in the non-compressed package format and the image layer file in the compressed package format that passes the second verification in an image layer corresponding to the image layer file.

10. The method according to claim 1, wherein the image layer file comprises a first initial digest and a third initial digest; the first initial digest is a hash value determined based on the image layer file in the non-compressed package format, and the third initial digest is a hash value determined based on an actual storage format of the image layer file.

11. The method according to claim 10, wherein before performing the mounting processing on the image layer file in the non-compressed package format, and performing the second verification and the mounting processing on the image layer file in the compressed package format, the method comprises:
determining the actual storage format of the image layer file according to the first initial digest and the third initial digest of the image layer file, wherein the actual storage format is the non-compressed package format or the compressed package format.

12. The method according to claim 11, wherein determining the actual storage format of the image layer file according to the first initial digest and the third initial digest of the image layer file comprises:
upon determining that the first initial digest of the image layer file is consistent with the third initial digest of the image layer file, determining that the actual storage format of the image layer file is the non-compressed package format;
upon determining that the first initial digest of the image layer file is inconsistent with the third initial digest of the image layer file, determining that the actual storage format of the image layer file is the compressed package format.

13. The method according to claim 1, further comprising:
calculating a hash value of the image layer file to obtain a third calculated digest;
upon determining that the third calculated digest of the image layer file is consistent with a third initial digest, determining that the image layer file passes the first verification;
upon determining that the third calculated digest of the image layer file is inconsistent with the third initial digest, determining that the image layer file fails the first verification.

14. An electronic device, comprising:
at least one processor; and
a memory communicatively connected to the at least one processor; wherein,
the memory stores instructions executable by the at least one processor, and the instructions are executed by the at least one processor to cause the at least one processor to:
acquire, in response to an image pull request, a target file indicated by the image pull request, the target file comprising at least one image layer file; wherein the image pull request indicates that the target file is to undergo mounting processing;
after determining that the image layer file passes a first verification, perform mounting processing on an image layer file of the at least one image layer file in a case that the image layer file is in a non-compressed package format, and perform a second verification and mounting processing on an image layer file of the at least one image layer file in a case that the image layer file is in a compressed package format.

15. The electronic device according to claim 14, wherein the processing request comprises path information of the directory metadata, and the instructions further cause the at least one processor to:
upon determining that an actual storage format of each image layer file is the non-compressed package format, serially mount each image layer file in an image layer corresponding to the image layer file.

16. The electronic device according to claim 14, wherein the processing request comprises path information of the directory metadata, and the instructions further cause the at least one processor to:
upon determining that an actual storage format of each image layer file is the compressed package format, perform the second verification on each image layer file in parallel;
after determining that the image layer file passes the second verification, serially mount the image layer file that passes the second verification in an image layer corresponding to the image layer file.

17. The electronic device according to claim 16, wherein the image layer file comprises a first initial digest, and the first initial digest is a hash value determined based on the image layer file in the non-compressed package format;
wherein the at least one processor is configured to perform the following steps for each image layer file in parallel:
decompressing the image layer file to obtain a decompressed image layer file, and calculating a hash value of the decompressed image layer file to obtain a first calculated digest;
upon determining that the first calculated digest corresponding to the image layer file is consistent with the first initial digest, determining that the image layer file passes the second verification; upon determining that the first calculated digest corresponding to the image layer file is inconsistent with the first initial digest, determining that the image layer file fails the second verification.

18. The electronic device according to claim 16, wherein the image layer file comprises a plurality of sub-files, the sub-file has a second initial digest, and the second initial digest is a hash value determined based on the sub-file in the non-compressed package format;
wherein the at least one processor is configured to perform the following steps for each image layer file in parallel:
for a current image layer file, verifying each sub-file of the current image layer file based on a second initial digest of each sub-file of the current image layer file;
upon determining that all of the sub-files of the current image layer file pass the verification, determining that the current image layer file passes the second verification; if it is determined that any of the sub-files of the current image layer file fails the verification, determining that the current image layer file fails the second verification.

19. The electronic device according to claim 18, wherein the processing request comprises path information of the directory metadata, and the instructions further cause the at least one processor to:
serially verify each sub-file of the current image layer file based on the second initial digest of each sub-file of the current image layer file; or,
verify each sub-file of the current image layer file in parallel based on the second initial digest of each sub-file of the current image layer file.

20. A non-transitory computer-readable storage medium storing computer instructions, wherein the computer instructions are used to cause a computer to execute the following steps:
in response to an image pull request, acquiring a target file indicated by the image pull request, the target file comprising at least one image layer file, wherein the image pull request indicates that the target file is to undergo mounting processing;
after determining that the image layer file passes a first verification, performing mounting processing on an image layer file of the at least one image layer file in a case that the image layer file is in a non-compressed package format, and performing a second verification and mounting processing on an image layer file of the at least one image layer file in a case that the image layer file is in a compressed package format.
